(19) United States
(12) Patent Application Publication
(10) Pub. No.: US 2016/0235016 A1
(43) Pub. Date: Aug. 18, 2016

(54) SOFT PLANT POT

(71) Applicant: Tsung-Yao HSU, Pingtung County 905 (TW)

(72) Inventor: Tsung-Yao HSU, Pingtung County 905 (TW)

(21) Appl. No.: 14/620,364

(22) Filed: Feb. 12, 2015

(51) Int. Cl. A01G 9/02

(52) U.S. Cl. CPC A01G 9/02

(57) ABSTRACT

A soft plant pot including a body (1) having a receiving space (13) with an upper opening. The receiving space (13) can receive a plant. The body (1) includes a bottom wall (12) having a drain hole (121) for draining water. An annular ring (124) is formed on an inner face of the bottom wall (12) and surrounds the drain hole (121). The annular ring (124) includes a notch (123) to define an arc-shaped section (122). The arc-shaped section (122) has a height above the inner face of the bottom wall (12) to create a gap between the bottom wall (12) and the plant. The notch (123) and the gap allow gas and fluid to flow therethrough.

### BACKGROUND OF THE INVENTION

The present invention relates to a plant pot for cultivating a plant and, more particularly, to a soft plant pot for cultivating a plant.

A plant pot is a vessel including a bottom having holes for draining excessive water to avoid poor growth or even death of the roots of a plant cultivated in the plant pot due to excessive water. Plant pots include rigid plant pots, soft plant pots, and shallow planters. Soft plant pots are generally used for planting seedlings of plants, because the seedlings can easily be removed from the soft plant pots during transplantation.

With reference to FIGS. 5 and 6, a plant is generally planted in a plastic, soft plant pot to allow easy transplantation in the future. A typical soft plant pot includes a body 2 having a peripheral wall 21 and a bottom wall 22. The peripheral wall 21 is tubular and includes two open ends. The lower edge of the peripheral wall 21 is connected to the periphery of the bottom wall 22. Thus, the peripheral wall 21 and the bottom wall 22 together define a receiving space 23 for receiving a plant to be cultivated. Since the body 1 is made of a soft material, a plurality of ribs 211 is provided on the peripheral wall 21 to support the body 2. The bottom wall 22 includes a drain hole 221 for draining water. However, the inner face of the bottom wall 22 is plane and, thus, in intimate contact with the plant in the body 2, resulting in poor permeation to air and a poor water draining effect. Thus, the body 2 can not drain water in time after watering the plant, such that the air permeability in the environment in the body 2 is poor, resulting in rotting of the roots of the plant.

### BRIEF SUMMARY OF THE INVENTION

To solve the above disadvantages, the present invention provides a soft plant pot including a body having a receiving space with an upper opening. The receiving space is adapted to receive a plant. The body includes a bottom wall having a drain hole for draining water. An annular ring is formed on an inner face of the bottom wall and surrounds the drain hole. The annular ring includes a notch to define an arc-shaped section. The arc-shaped section has a height above the inner face of the bottom wall to create a gap between the bottom wall and the plant. The notch and the gap are adapted to allow gas and fluid to flow therethrough.

Preferably, the body includes a peripheral wall extending upward from a periphery of the bottom wall. The bottom wall and the peripheral wall together define the receiving space. The peripheral wall includes a first annular ring for maintaining the upper opening.

Preferably, the peripheral wall includes an upper portion having an annular groove. The annular groove includes an upper edge adapted to serve as a reference line for a height of the plant in the body. The annular groove further includes a lower edge adapted for preventing roots of the plant from growing to an outside of the body.

Preferably, a height of the first annular ring of the peripheral wall above the bottom wall is larger than a height of the annular groove of the peripheral wall above the bottom wall.

Preferably, the peripheral wall further includes a plurality of inverted triangular recessed portions spaced from each other. Each of the plurality of inverted triangular recessed portions extends downward and inward from the lower edge of the annular groove and defines a space in communication with a space defined by the annular groove. Each of the plurality of inverted triangular recessed portions includes a wall adapted for preventing the roots of the plant from growing to the outside of the body.

Preferably, the peripheral wall further includes a plurality of ribs spaced from each other. Each of the plurality of ribs protrudes outward from an outer face of the peripheral wall and forms a guiding groove in an inner face of the peripheral wall. The gas and the fluid are adapted to flow through a gap between the plant and each of the plurality of ribs.

Preferably, each of the plurality of ribs extends downward from the lower edge of the annular groove or the wall of one of the plurality of inverted triangular recessed portions to the bottom wall along the peripheral wall.

Preferably, the peripheral wall further includes a second annular ring having a plurality of sections. Each of the plurality of sections of the second annular ring extends between two adjacent ribs.

The present invention will become clearer in light of the following detailed description of illustrative embodiments of this invention described in connection with the drawings.

### DESCRIPTION OF THE DRAWINGS

FIG. 1 is a top, perspective view of a soft plant pot according to the present invention.

FIG. 2 is a bottom, perspective view of the soft plant pot according to the present invention.

FIG. 3 is a perspective view of the soft plant pot of FIG. 1, with a portion of the soft plant pot cutaway to show inverted-triangular sections.

FIG. 4 is a perspective view of the soft plant pot of FIG. 1, with a portion of the soft plant pot cutaway to show a cross section of a rib.

FIG. 5 is a perspective view of a conventional soft plant pot.

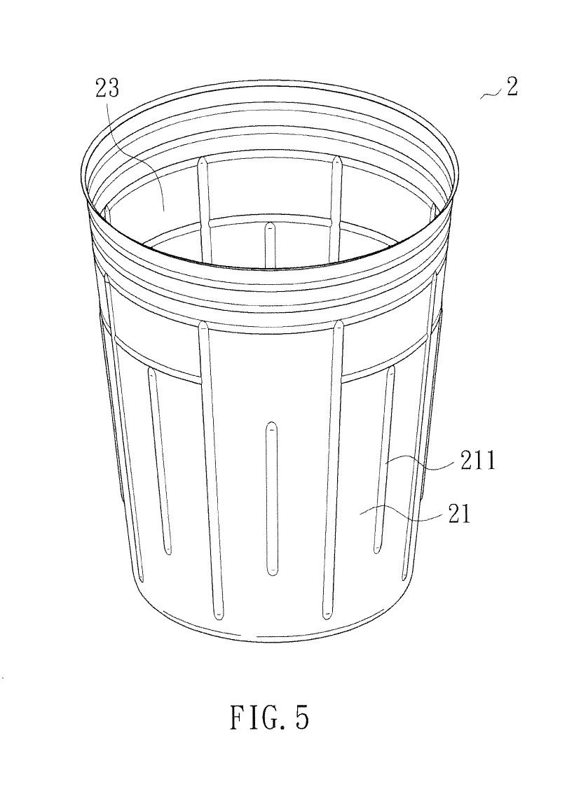

FIG. 6 is a perspective view of the conventional soft plant pot, with a portion of the soft plant pot cutaway.

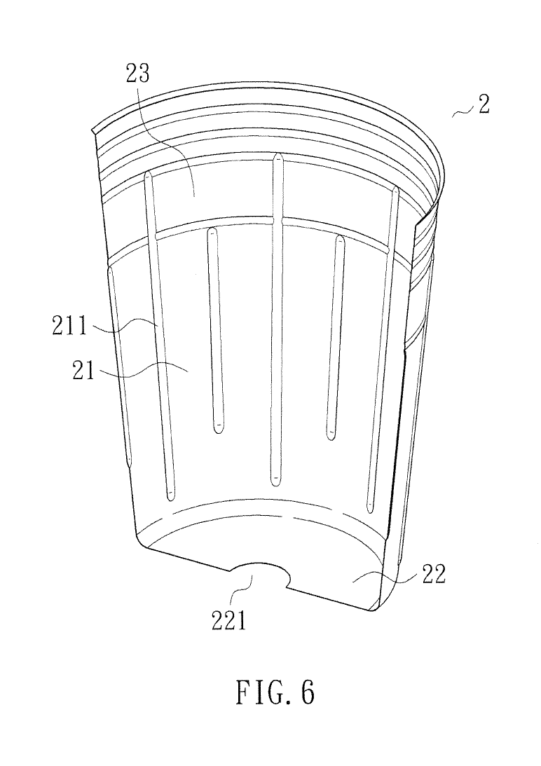

### DETAILED DESCRIPTION OF THE INVENTION

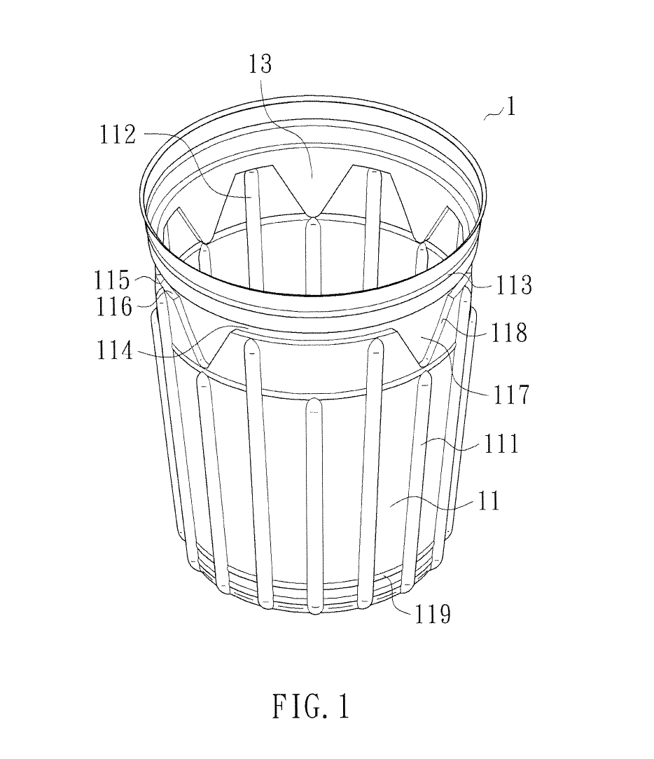

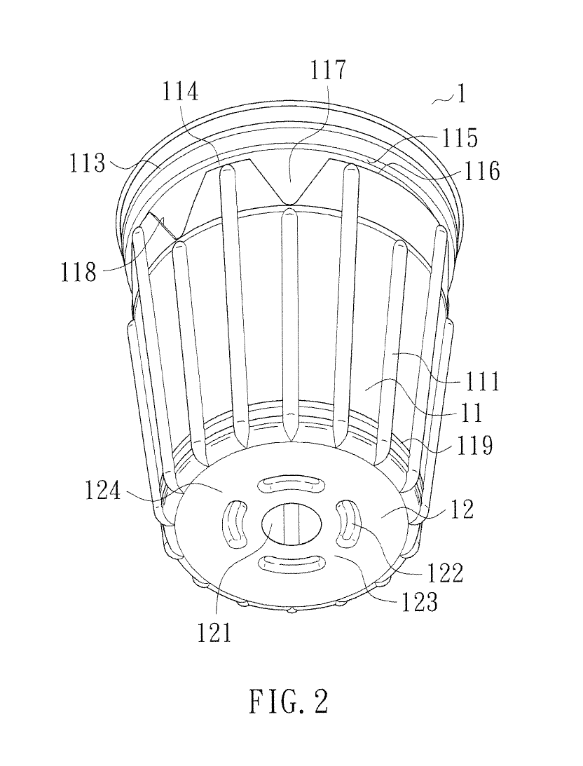

With reference to FIGS. 1 and 2, a soft plant pot according to the present invention includes a body 1 including a receiving space 13 having an upper opening. The receiving space 13 is adapted to receive a plant to be cultivated or to be transplanted in the future. The body 1 includes a bottom wall 12 having a drain hole 121 for draining water. An annular ring 124 is formed on an inner face of the bottom wall 12 and surrounds the drain hole 121. The annular ring 124 includes a notch 123 to define an arc-shaped section 122. The arc-shaped section 122 has a height above the inner face of the bottom wall 12 to create a gap between the bottom wall 12 and the plant. In the embodiment shown, the annular ring 124 has four notches 123 to define four arc-shaped sections 122. Each section 122 has a width of 0.5±5% cm and a height of 0.2±5% cm. The notches 123 and the gaps are adapted to allow gas and fluid to flow therethrough.

Due to the height of each arc-shaped section, a gap exist between the plant (such as, but not limited to a water plant) in the receiving space 13 and the bottom wall 12. Since the arc-shaped section 122 are annularly arranged, the arc-shaped sections 122 can be in surface contact with the plant such that formation of the gap between the bottom wall 12 and the plant is easier, providing excellent permeation to air in the interior of the body 1. In the embodiment shown, a notch 123 is provided between each two adjacent arc-shaped sections 122. Thus, water can pass through each notch 123 and then drain out of the body 1 via the drain hole 121. Thus, water will not accumulate in the body 1. As a result, the interior of the body 1 provides an environment with an excellent water draining effect and excellent permeation to air, which is suitable for a plant requiring an environment with good air permeation and good water draining effect.

With reference to FIGS. 1 and 2, in addition to the bottom wall 12, the body 1 further includes a peripheral wall 11 extending upward from a periphery of the bottom wall 12. The bottom wall 12 and the peripheral wall 11 together define the receiving space 13. Since the body 1 is a thin, soft body made of a plastic material, a first annular ring 113 is provided on an upper portion the peripheral wall 11 for maintaining the shape of the upper opening of the body 1. Since cultivation and transplantation are carried out by manual operation nowadays, watering has a certain standard in order to achieve normalization and standardization under mass production. Thus, the first annular ring 113 can serve as a reference line for watering.

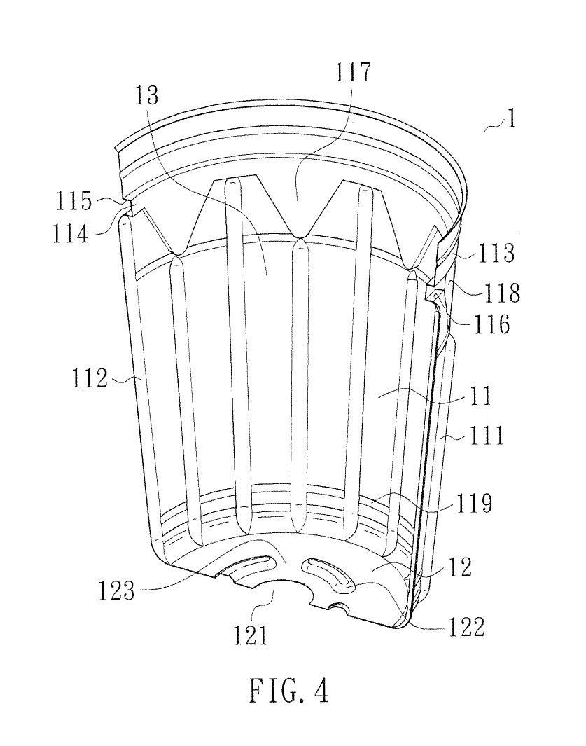

With reference to FIGS. 1, 3, and 4, to achieve normalization and standardization of planting, the upper portion of the peripheral wall 11 includes an annular groove 114. In the embodiment shown, the annular groove 114 has a width of 0.4±5% cm and a depth of 0.2±5% cm. The annular groove 114 includes an upper edge 115 adapted to serve as a reference line for a height of the plant in the body 11.

With reference to FIGS. 1, 2, and 4, the annular groove 114 further includes a lower edge 116 adapted for stopping roots of the plant and, thus, preventing the roots of the plant from growing to the outside of the body 1. To avoid the roots of the plant from accumulating on the lower edge 116 and, thus, becoming too dense (which would result in poor air permeation of the roots and adversely affect the growth), the peripheral wall 11 further includes a plurality of inverted triangular recessed portions 117 spaced from each other. Each inverted triangular recessed portion 117 extends downward and inward from the lower edge 116 of the annular groove 114 and defines a space in communication with a space defined by the annular groove 114. In the embodiment shown, each inverted triangular recessed portion 117 has a depth of 0.2±5% cm. Each inverted triangular recessed portion 117 includes a wall 118 adapted for preventing the roots of the plant from growing to the outside of the body 1. Furthermore, the roots of the plant will disperse to the wall 118 of each inverted triangular recessed portion 117 rather than dense distribution on the lower edge 116.

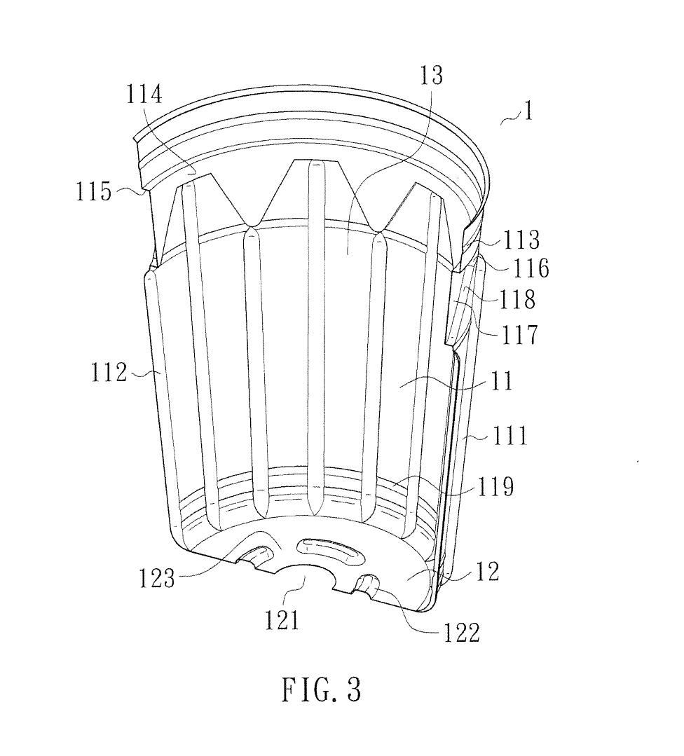

With reference to FIGS. 1 and 3, in addition to providing the gap between the plant in the receiving space 13 and the bottom wall 12, the arc-shaped sections 122 on the bottom wall 12 also avoid the roots of the plant from growing to the outside of the body 1 via the drain hole 121.

With reference to FIGS. 1 and 3, since the first annular ring 113 is the reference line for watering and since the upper edge 115 of the annular groove 114 is the reference line for the height of the plant, a height of the first annular ring 113 of the peripheral wall 11 above the bottom wall 12 is larger than a height of the annular groove 114 of the peripheral wall 11 above the bottom wall 12 to assure that the plant can obtain sufficient water.

Since the body 1 is a thin, soft body made of a plastic material, the peripheral wall 11 further includes a plurality of downwardly extending ribs 111 for supporting the body 1. The ribs 111 are spaced from each other. In addition to the support from the ribs 111, the peripheral wall 11 further includes a second annular ring 119 including a plurality of sections. Each section of the second annular ring 119 extends between two adjacent ribs 111. By the vertically extending ribs 111 and the second annular ring 119 extending in the circumferential direction and intersecting the ribs 111, the body 1 is firmer. In the embodiment shown, the peripheral wall 11 includes two second annular rings 119 on a lower portion thereof to make the body 1 firmer.

With reference to FIGS. 1-3, since the lower edge 116 of the annular groove 114 and the wall 118 of each inverted triangular recessed portion 117 avoid the roots of the plant from growing to the outside of the body 1, the roots of the plant mainly grow inside the body 1. Thus, the air permeation and water drainage of the body 1 are critical to the growth of the plant. Therefore, each rib 111 protrudes outward from an outer face of the peripheral wall 11. In the embodiment shown, each rib 111 has a width of about 0.3-0.4 cm and a height of 0.2±5% cm. Furthermore, each rib 111 forms a guiding groove 112 in an inner face of the peripheral wall 11. The gas and the fluid are adapted to flow through a gap between the plant and each rib 111. Preferably, each rib 111 extends to the bottom wall 12 such that the gap between the plant and each rib 111 extends to the bottom wall 12 to provide better air permeation and better water drainage, providing an environment suitable for the growth of the plant.

With reference to FIGS. 1-4, each rib 111 extends downward from the lower edge 116 of the annular groove 114 or the wall 118 of one of the inverted triangular recessed portions 117 to the bottom wall 12 along the peripheral wall 11, maintaining the integrity of the lower edge 116 of the annular groove 114 and the wall 118 of each inverted triangular recessed portion 117 to avoid the roots of the plant from growing to the outside of the body 1.

Although specific embodiments have been illustrated and described, numerous modifications and variations are still possible without departing from the scope of the invention. The scope of the invention is limited by the accompanying claims.

1. A soft plant pot comprising:
a body (1) including a receiving space (13) having an upper opening, with the receiving space (13) adapted to receive a plant, with the body (1) including a bottom wall (12) having a drain hole (121) for draining water, with an annular ring (124) formed on an inner face of the bottom wall (12) and surrounding the drain hole (121), with the annular ring (124) including a notch (123) to define an arc-shaped section (122), with the arc-shaped section (122) having a height above the inner face of the bottom wall (12) to create a gap between the bottom wall (12) and the plant, and with the notch (123) and the gap adapted to allow gas and fluid to flow therethrough.

2. The soft plant pot as claimed in claim 1, with the body (1) including a peripheral wall (11) extending upward from a periphery of the bottom wall (12), with the bottom wall (12) and the peripheral wall (11) together defining the receiving space (13), and with the peripheral wall (11) including a first annular ring (113) for maintaining the upper opening.

3. The soft plant pot as claimed in claim 2, with the peripheral wall (11) including an upper portion having an annular groove (114), with the annular groove (114) including an upper edge (115) adapted to serve as a reference line for a height of the plant in the body (11), and with the annular groove (114) further including a lower edge (116) adapted for preventing roots of the plant from growing to an outside of the body (1).

4. The soft plant pot as claimed in claim 3, with a height of the first annular ring (113) of the peripheral wall (11) above the bottom wall (12) being larger than a height of the annular groove (114) of the peripheral wall (11) above the bottom wall (12).

5. The soft plant pot as claimed in claim 3, with the peripheral wall (11) further including a plurality of inverted triangular recessed portions (117) spaced from each other, with each of the plurality of inverted triangular recessed portions (117) extending downward and inward from the lower edge (116) of the annular groove (114) and defining a space in communication with a space defined by the annular groove (114), and with each of the plurality of inverted triangular recessed portions (117) including a wall (118) adapted for preventing the roots of the plant from growing to the outside of the body (1).

6. The soft plant pot as claimed in claim 2, with the peripheral wall (11) further including a plurality of ribs (111) spaced from each other, with each of the plurality of ribs (111) protruding outward from an outer face of the peripheral wall (11) and forming a guiding groove (112) in an inner face of the peripheral wall (11), and with the gas and the fluid adapted to flow through a gap between the plant and each of the plurality of ribs (111).

7. The soft plant pot as claimed in claim 6, with each of the plurality of ribs (111) extending downward from the lower edge (116) of the annular groove (114) or the wall (118) of one of the plurality of inverted triangular recessed portions (117) to the bottom wall (12) along the peripheral wall (11).

8. The soft plant pot as claimed in claim 6, with the peripheral wall (11) further including a second annular ring (119) having a plurality of sections, with each of the plurality of sections of the second annular ring (119) extending between two adjacent ribs (111).
